(19) United States
(12) Patent Application Publication
(10) Pub. No.: US 2019/0092055 A1
(43) Pub. Date: Mar. 28, 2019

(54) PAPER FEEDING DEVICE FOR PRINTER

(71) Applicant: DS GLOBAL, Seoul (KR)

(72) Inventor: YONG DUK LEE, Gunpo-si (KR)

(21) Appl. No.: 16/123,306

(22) Filed: Sep. 6, 2018

(30) Foreign Application Priority Data
Sep. 27, 2017 (KR) 10-2017-0125529

(51) Int. Cl. B41J 13/10; B41J 13/076; B41J 13/00

(52) U.S. Cl. CPC B41J 13/103; B41J 2/32; B41J 13/0018; B41J 13/076

(57) ABSTRACT

Provided is a paper feeding device for a printer that is capable of absorbing an impact occurring when a rear end of paper escapes from the outer peripheral surface of a pickup roller and thus comes into contact with a bottom surface of a paper stacking part. The paper feeding device for a printer includes: a paper stacking part for stackedly accommodating at least one or more sheets of paper therein; a pickup roller protruding from a bottom surface of the paper stacking part to feed the paper forward; and buffers linearly protruding from the bottom surface of the paper stacking part to absorb the impact occurring when the rear end of the paper escapes from the outer peripheral surface of the pickup roller and then comes into contact with the bottom surface of the paper stacking part.

### TECHNICAL FIELD

The present invention relates to a paper feeding device for a printer, and more particularly, to a paper feeding device for a printer that is capable of absorbing an impact occurring when a rear end of paper escapes from the outer peripheral surface of a pickup roller and thus comes into contact with a bottom surface of a paper stacking part.

### BACKGROUND ART

A camera mounted on a smart device like a smartphone has similar performance to a general digital camera, and many people have taken their pictures with their smart device carried always with them, not with a digital camera. Accordingly, a consumer's desire to take his or her picture and to instantly print the picture, without any separate conversion, has been gradually increased.

So as to satisfy such consumer's desire, photo printers have been proposed so that pictures on smartphones can be instantly printed whenever and wherever.

There are various kinds of photo printers, but among them, particularly, a photo printer is proposed wherein printing paper to which a zero-ink printing technology is adopted is used, thereby requiring no ink or cartridge to reduce the maintenance cost thereof. In case of such zero-ink printing technology, the part corresponding to the cartridge is contained in the paper, and accordingly, only heat is used to express colors. That is, dyes, which respond to heat and thus express colors, are laminated on the paper, so that the heating temperature or heating time of a head is controlled to print images (pictures) or texts.

FIGS. 1 and 2 show a conventional portable photo printer to which the zero-ink printing technology is adopted. As shown, the conventional photo printer 100 includes a base 110, a pickup roller R1, a platen roller R2, a thermal head 140, a mounting part 150, and pressurizing means 160.

The base 110 has a paper stacking part 111 disposed thereon to stackedly accommodate paper sheets P therein and a lower base 115 extended forward from the underside thereof, and in this case, separate formation of the lower base 115 from the base 110 provides easiness in manufacturing. Of course, they may be formed unitarily with each other.

The pickup roller 40 protrudes from the bottom surface of the paper stacking part 111 of the base 15 to forward feed the paper located at the lowermost position among the stacked paper.

On the other hand, a paper pressurizing member 120 is provided to elastically pressurize the paper stacked on the paper stacking part 111 downward, and the paper pressurizing member 120 is coupled to a top of a side surface of the base 110 in such a manner as to be inclined downward toward the pickup roller R1 to pressurize the paper downward. If the paper is pressurized, like this, a frictional force between the paper and the pickup roller R1 becomes large to rotate the pickup roller R1, so that the paper located at the lowermost position among the stacked paper can be gently fed forward.

The platen roller R2 is adapted to discharge the paper fed by the pickup roller R1 forward and has a rotary shaft coupled to the lower base 115.

The thermal head 140 is disposed above the platen roller R2 and under the mounting part 151 and is adapted to apply given heat to the paper to express colors corresponding to the given heat, thereby printing images or texts.

Further, a PCB is provided to control a heating temperature and heating time of the thermal head 140.

So as to allow a space between the thermal head 140 and the platen roller R2 to be expanded at the time when the paper advances into the space between the thermal head 140 and the platen roller R2, further, the mounting part 151 has hinge holes 152 formed on the rear side thereof in such a manner as to be coupled to rotary shafts 113 disposed on the side walls of the base 110.

Further, the thermal head 140 comes into close contact with the paper to transfer the heat to the paper, and so as to allow the thermal head 140 to come into close contact with the paper, the pressurizing means 160 is provided to pressurize the thermal head 140 downward.

FIG. 3 shows paper feeding processes of the conventional photo printer. (a) of FIG. 3 shows a state wherein paper sheets are staked in the paper stacking part. As shown, the top of the stacked paper is pressurized against the paper pressurizing member 120, and the paper P1 located at the lowermost position among the stacked paper comes into close contact with the pickup roller R1.

In this state, if the pickup roller R1 rotates, the paper P1, which is located at the lowermost position among the stacked paper, that is, comes into close contact with the pickup roller R1, is fed forward (See (b) of FIG. 3).

Next, the rear end of the paper is fed through the frictional force with the outer peripheral surface of the pickup roller R1 and is then separated from the outer peripheral surface of the pickup roller R1 at the point where the protruding portion of the pickup roller R1 is ended (See (c) of FIG. 3).

By the way, while the rear end of the paper is coming into close contact with the outer peripheral surface of the pickup roller R1 and is being fed, it gently falls downward along the outer peripheral surface of the pickup roller R1, but at the moment when it comes into contact with the bottom surface of the paper stacking part 111, an impact is applied thereto.

The application of the impact to the rear end of the paper gives an influence on the front end of the paper. In detail, if the rear end of the paper comes into contact with the bottom surface to cause the impact, the front end of the paper, which is engagedly disposed between the platen roller R2 and the thermal head 140 and forms images, may swing. A portion of the paper, which is engagedly disposed between the platen roller R2 and the thermal head 140 and forms images, has to be rigidly fixed, without any swing, so as to achieve high quality printing. If there is any swing on the front end (a portion to be printed) of the paper, accordingly, stripes may occur in a direction coming into contact with the thermal head 140, thereby making a quality of a photo printed deteriorated badly.

### [NATIONAL RESEARCH AND DEVELOPMENT PROGRAM SUPPORTING THE INVENTION] TECHNOLOGY DEVELOPMENT PROGRAM OF MINISTRY OF SMES AND STARTUPS

[Project No.] 52423846
[Ministry Name] Ministry of SMEs and Startups
[Research Management Agency] Korea Technology & Information Promotion Agency for SMEs
[Research Program Name] Technology Development Program
[Research Project Name] Basic technology development on engine and system for instant photo camera outputting 3×4 inches color photo
[Contribution Rate] ⅕
[Host Institution] DS Global Co., Ltd
[Period of Time for Research] Sep. 1, 2016 to Aug. 31, 2018

### PRIOR ART DOCUMENT

### Patent Document

Patent Document 1 Korean Patent Application Laid-open No. 10-2017-0082404

### DISCLOSURE

### Technical Problem

Accordingly, the present invention has been made in view of the above-mentioned problems occurring in the prior art, and it is an object of the present invention to provide a paper feeding device for a printer that is capable of absorbing an impact occurring when a rear end of paper escapes from the outer peripheral surface of a pickup roller and thus comes into contact with a bottom surface of a paper stacking part.

### Technical Solution

To accomplish the above-mentioned object, according to the present invention, there is provided a paper feeding device for a printer, including: a paper stacking part for stackedly accommodating at least one or more sheets of paper therein; a pickup roller protruding from a bottom surface of the paper stacking part to feed the paper forward; and buffers linearly protruding from the bottom surface of the paper stacking part to absorb the impact occurring when the rear end of the paper escapes from the outer peripheral surface of the pickup roller and then comes into contact with the bottom surface of the paper stacking part.

According to the present invention, desirably, each buffer protrudes from the bottom surface of the paper stacking part in a paper feed direction and a protruding thickness (height) of the buffer is lower than the highest point of the pickup roller.

According to the present invention, desirably, each buffer includes a first tapered portion gradually decreased in the protruding thickness toward the front side thereof so that as the paper is fed forward, the rear end of the paper is close to the bottom surface of the paper stacking part.

According to the present invention, desirably, each buffer includes a second tapered portion gradually decreased in the protruding thickness toward the rear side thereof. In detail, desirably, an inclination of the second tapered portion is lower than an inclination of the first tapered portion.

According to the present invention, desirably, each buffer includes a flatten portion formed between the first tapered portion and the second tapered portion in such a manner as to be constant in the protruding thickness.

According to the present invention, desirably, the buffers are formed on the outsides of both ends of the pickup roller.

### Advantageous Effects

According to the present invention, the paper feeding device for a printer can absorb an impact occurring when a rear end of paper escapes from the outer peripheral surface of the pickup roller and thus comes into contact with the bottom surface of the paper stacking part.

In addition, the paper feeding device for a printer according to the present invention can minimize bad influences caused by the impact applied to the paper, for example, occurrence of stripes on the paper.

### BRIEF DESCRIPTION OF DRAWINGS

FIGS. 1 and 2 show a conventional portable photo printer.

FIG. 3 shows paper feeding processes of the conventional portable photo printer.

FIGS. 4 to 6 show a paper feeding device for a printer according to the present invention.

FIGS. 7 to 9 show paper feeding processes to the printer in the paper feeding device according to the present invention.

FIGS. 10 to 12 show various examples of a buffer in the paper feeding device according to the present invention.

### MODE FOR INVENTION

Hereinafter, an explanation on a configuration and an operation of a paper feeding device for a printer according to the present invention will be in detail given with reference to the attached drawing.

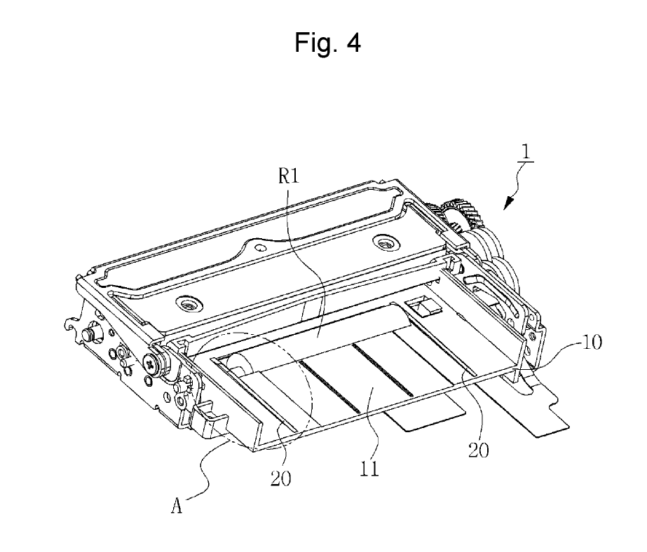

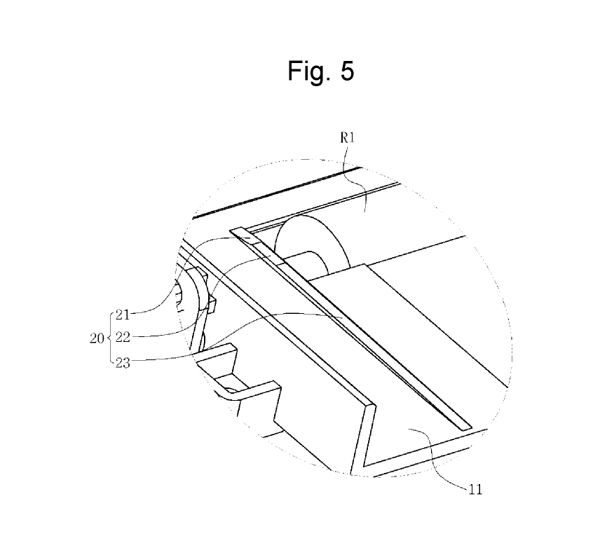

As shown in FIGS. 4 and 5, a paper feeding device 1 for a printer according to the present invention includes a paper stacking part 10, a pickup roller R1, pressurizing means (not shown), and buffers 20.

The paper stacking part 10 provides a space in which at least one or more sheets of paper are accommodatedly stacked up and down onto each other.

The pickup roller R1 is configured to allow a portion of a top peripheral surface thereof to protrude from a bottom surface 11 of the paper stacking part 10 to forward feed the paper coming into close contact with the protruding top peripheral surface thereof. In detail, the top peripheral surface of the pickup roller R1 comes into contact with the paper located at the lowermost position among the stacked paper, and if the pickup roller R1 rotates, in this state, it can feed the paper located at the lowermost position forward.

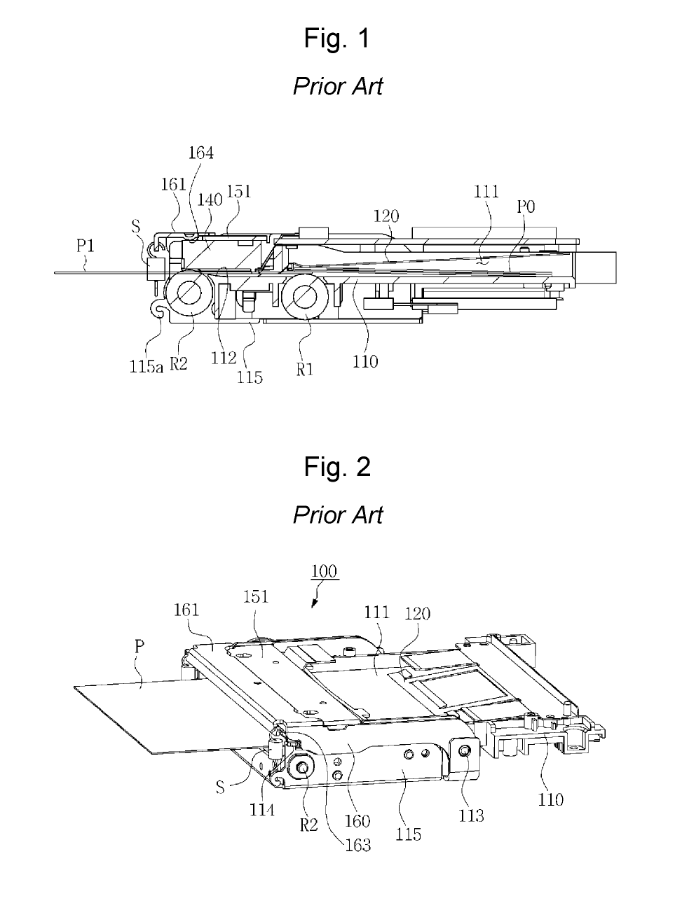

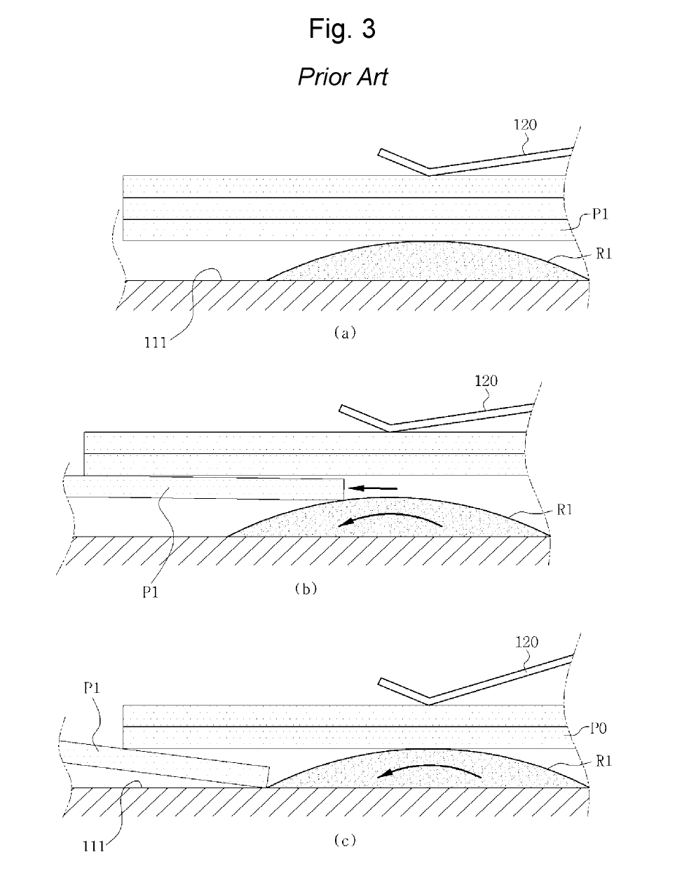

The pressurizing means is adapted to allow the paper to be brought into close contact with the pickup roller R1 so that the pickup roller R1 and the paper rub against each other to feed the paper, without any slipping. The pressurizing means can be utilized with the paper pressurizing member 120 as known means, as shown in FIG. 1.

Particularly, the paper feeding device 1 according to the present invention is provided with the buffers 20 that are adapted to absorb an impact occurring when the rear end of the paper escapes from the protruding top peripheral surface of the pickup roller R1 and then comes into contact with the bottom surface 11 of the paper stacking part 10. In more detail, the buffers 20 are adapted to allow the rear end of the paper to be separated from the outer peripheral surface of the pickup roller R1 and to slowly fall downward on the bottom surface 11, thereby softening the impact occurring at that time.

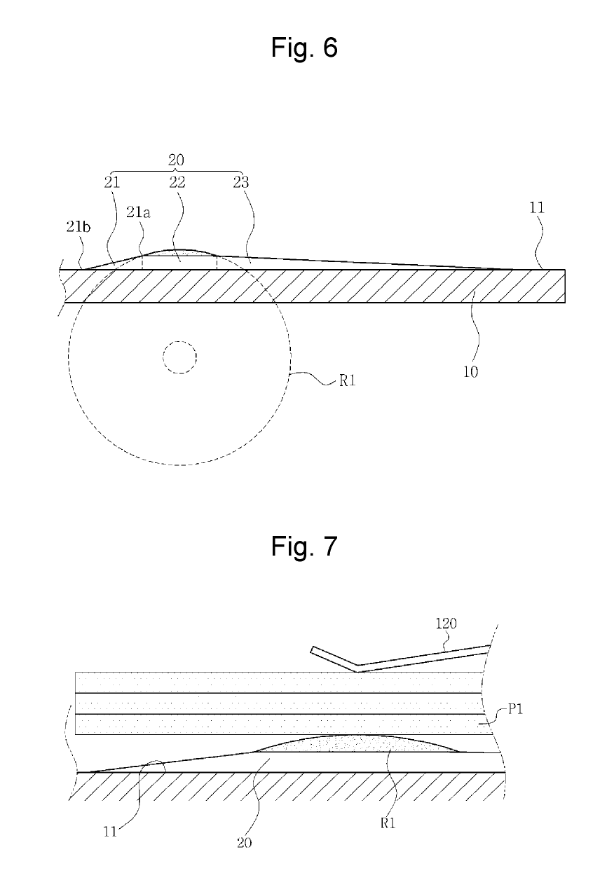

Now, an explanation on the configuration and operation of the buffers 20 will be in detail given with reference to FIGS. 5 and 6.

As shown, each buffer 20 linearly protrudes from the bottom surface 11 of the paper stacking part 10. Further, the buffers 20 are formed on the outsides of both ends of the pickup roller R1 in such a manner as to be parallel with each other.

Also, the protruding thickness of the buffer 20 is lower than the highest point of the pickup roller R1.

Furthermore, the buffer 20 has a first tapered portion 21 gradually decreased in the protruding thickness toward the front side thereof. The highest point 21a of the first tapered portion 21 is lower than the peak of the pickup roller R1, and the lowest point 21b thereof is equal to the bottom surface 11. The first tapered portion 21 receives the rear end of the paper from the pickup roller R1 and slowly moves the paper to the bottom surface 11 of the paper stacking part 10, thereby minimizing the impact transferred to the rear end of the paper. According to the present invention, the highest point 21a of the first tapered portion 21 is formed located in a direction of 10 to 12 o'clock.

Moreover, the buffer 20 has a second tapered portion 23 gradually decreased in the protruding thickness toward the rear side thereof. The second tapered portion 23 is adapted to minimize a portion with which the paper comes into contact, thereby reducing the load occurring upon paper feeding.

Further, the buffer 20 has a flatten portion 22 formed between the first tapered portion 21 and the second tapered portion 23 in such a manner as to be constant in the protruding thickness from the bottom surface 11.

On the other hand, an inclination of the second tapered portion 23 is lower than an inclination of the first tapered portion 21. In detail, an absolute value of the inclination of the second tapered portion 23 is smaller than an absolute value of the inclination of the first tapered portion 21.

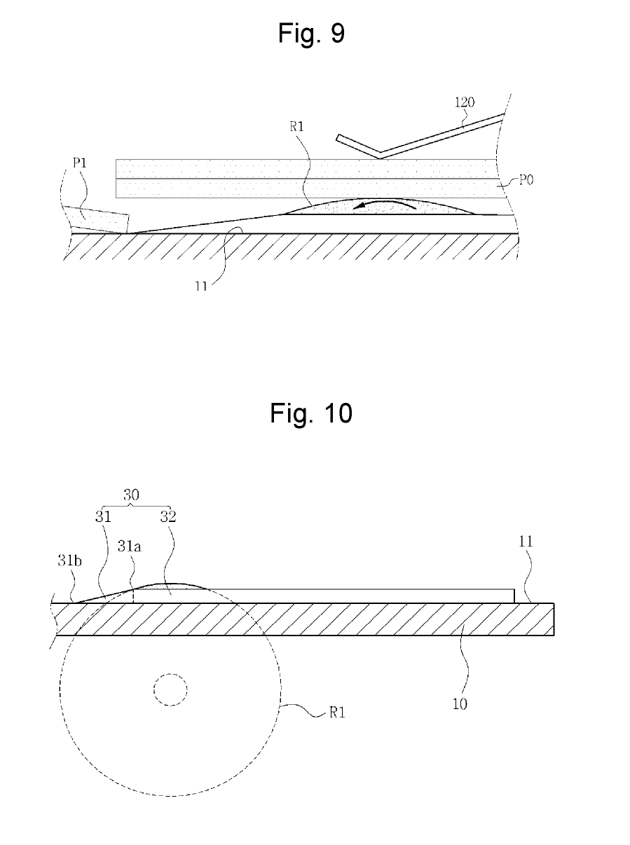

Next, an explanation on an operating state of the paper feeding device 1 according to the present invention will be given with reference to FIGS. 7 and 9.

As shown in FIG. 7, first, a portion of the top peripheral surface of the pickup roller R1 protrudes from the bottom surface 11 of the paper stacking part 10, and a plurality of paper sheets are stacked on the top peripheral surface of the pickup roller R1. Further, the paper pressurizing member 120 pressurizes the top of the stacked paper downward.

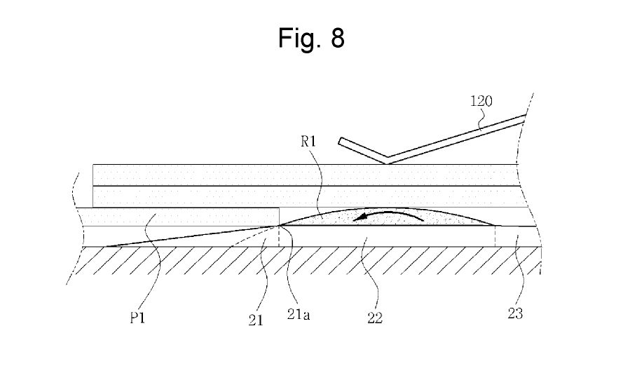

In this state, if the pickup roller R1 rotates in a counterclockwise direction, the paper P1, which is located at the lowermost position among the stacked paper, that is, comes into close contact with the pickup roller R1, is moved along the outer peripheral surface of the pickup roller R1 and is thus fed forward. As a result, the rear end of the paper P1 passes over the peak R1 and slowly falls downward. In this process, by the way, the rear end of the paper P1 comes into contact with the highest points 21a of the buffers 20 (See FIG. 8).

Next, the rear end of the paper P1 is separated from the outer peripheral surface of the pickup roller R1 and comes into contact with the first tapered portions 21 of the buffers 20, so that the rear end of the paper P1 is gently moved along the inclined surface of the first tapered portions 21 and slowly approaches the bottom surface 11 (See FIG. 9).

Under the above-mentioned processes, until the rear end of the paper P1 separated from the outer peripheral surface of the pickup roller R1 comes into contact with the bottom surface 11 of the paper stacking part 11, the rear end of the paper P1 is slowly moved along the first tapered portions 21 of the buffers 20, thereby minimizing the impact occurring during the movement.

Accordingly, the impact applied to the rear end of the paper is absorbed to in advance prevent the impact from being transferred to the front end of the paper on which images are being formed.

According to the present invention, the buffers 20 may be changed into various forms. For example, as shown in FIG. 10, the buffers 20 may be replaced with buffers 30 each having a first tapered portion 31 gradually decreased in the protruding thickness toward the front side thereof and a flatten portion extended flattenly from the first tapered portion 31 in such a manner as to have the protruding thickness equal to the highest point 31a of the first tapered portion 31.

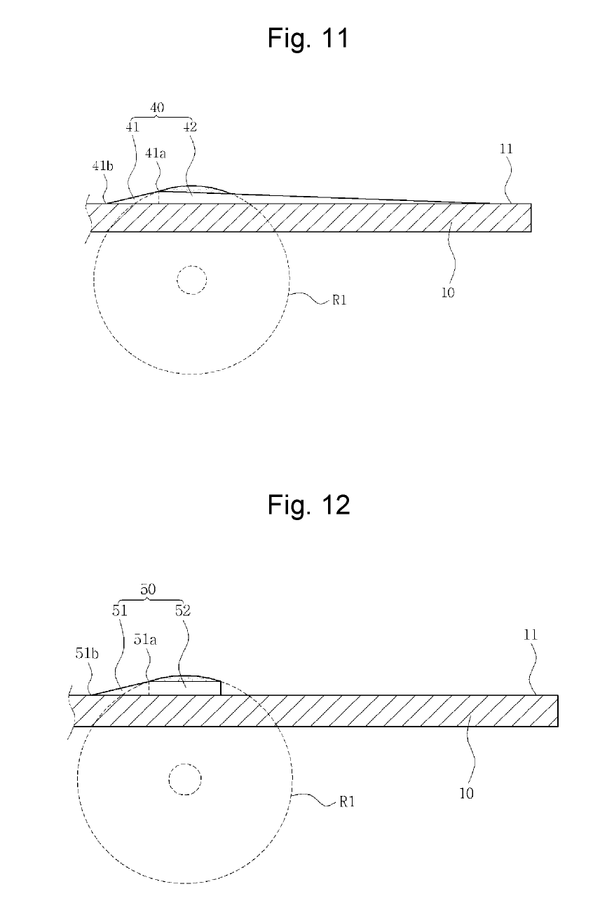

On the other hand, the buffers 20 may be replaced with buffers 40 each having a first tapered portion 41 gradually decreased in the protruding thickness toward the front side thereof and a second tapered portion 42 gradually decreased in the protruding thickness toward the rear side thereof in such a manner as to be adjacent to the first tapered portion 41, without having any flatten portion (See FIG. 11)

Further, the buffers 20 may be replaced with buffers 50 each having a first tapered portion 51 gradually decreased in the protruding thickness toward the front side thereof and a flatten portion 52 extended flattenly from the first tapered portion 51, without having any second tapered portion (See FIG. 12).

1. A paper feeding device for a printer, comprising:
a paper stacking part for stackedly accommodating at least one or more sheets of paper therein;
a pickup roller protruding from a bottom surface of the paper stacking part to feed the paper forward; and
buffers linearly protruding from the bottom surface of the paper stacking part to absorb an impact occurring when the rear end of the paper escapes from the outer peripheral surface of the pickup roller and then comes into contact with the bottom surface of the paper stacking part.

2. The paper feeding device according to claim 1, wherein each buffer protrudes from the bottom surface of the paper stacking part in a paper feed direction and a protruding thickness of the buffer is lower than the highest point of the pickup roller.

3. The paper feeding device according to claim 2, wherein each buffer comprises a first tapered portion gradually decreased in the protruding thickness toward the front side thereof so that as the paper is fed forward, the rear end of the paper is close to the bottom surface of the paper stacking part.

4. The paper feeding device according to claim 3, wherein each buffer comprises a second tapered portion gradually decreased in the protruding thickness toward the rear side thereof.

5. The paper feeding device according to claim 4, wherein an inclination of the second tapered portion is lower than an inclination of the first tapered portion.

6. The paper feeding device according to claim 4, wherein each buffer comprises a flatten portion formed between the first tapered portion and the second tapered portion in such a manner as to be constant in the protruding thickness.

7. The paper feeding device according to claim 1, wherein the buffers are formed on the outsides of both ends of the pickup roller.
